(19) United States
(12) Patent Application Publication
(10) Pub. No.: US 2004/0088301 A1
(43) Pub. Date: May 6, 2004

(54) Snapshot of a file system

(76) Inventors: Mallik Mahalingam, Sunnyvale, CA (US); Zhichen Xu, Sunnyvale, CA (US); Chunqiang Tang, Rochester, NY (US)

Correspondence Address: HEWLETT-PACKARD COMPANY, Intellectual Property Administration, P.O. Box 272400, Fort Collins, CO, 80527-2400, US

(21) Appl. No.: 10/284,109

(22) Filed: Oct. 31, 2002

(51) Int. Cl. G06F 17/30

(52) U.S. Cl. 707/100

(57) ABSTRACT

A method for generating a snapshot of a file system operable to store a plurality of objects includes receiving a snapshot time identifying a point in time in a history of the file system. The method further includes identifying at least one object available at the snapshot time.

### CROSS-REFERENCE

The present invention is related to pending:

U.S. application Ser. No. ______, (Attorney Docket No. 200207182-1) filed herewith, and entitled “SEMANTIC HASHING”, by Xu et al.; and

U.S. application Ser. No. ______, (Attorney Docket No. 200207181-1) filed herewith, and entitled “SEMANTIC FILE SYSTEM” by Xu et al.; which are all assigned to the assignee and are incorporated by reference herein in their entirety.

### FIELD OF THE INVENTION

The invention is generally related to file systems. More particularly, the invention is related to file system snapshots.

### BACKGROUND OF THE INVENTION

Fundamentally, computers are tools for helping people with their everyday activities. Processors may be considered as extensions to our reasoning capabilities and storage devices may be considered as extensions to our memories. File systems, including distributed file systems, are typically provided for accessing data organized in a hierarchal namespace, such as a directory tree, on storage devices, but the gap between the human memory and the simple hierarchical namespace of existing file systems makes these file systems hard to use.

The human brain typically remembers objects based on their contents or features. For example, when you run into an acquaintance, you may not remember the person's name, but you may recognize the person by features, such as a round face and a shiny smile. These identifying features are known as semantics or semantic information.

To bridge the gap between the human memory and the hierarchical namespace of existing file systems, people have used either separate tools or file systems that integrate rudimentary search capabilities. Tools such as GREP and other local search engines have to exhaustively search every document to match a pattern for identifying a document.

Some known semantic file systems, such as Semantic File System (SFS) and Hierarchy and Content (HAC), organize a namespace by executing queries based on semantic information and constructing the namespace with the results of the queries. For example, a directory in HAC may be created with all files that match the results of a query. These file systems, however, provide only simple keywords-based searches, and these file systems do not maintain any indices for minimizing retrieval times.

Also, known semantic file systems do not typically support archival functions, such as versioning. Generally, the most arduous task in restoring a backed up version is to find the desired file and the desired version of the file. Currently, the only way to locate the version is by remembering the date that the version was produced. In many cases, people are interested in files produced by other people, and are interested in versions with certain features. For example, in a digital movie studio an artist may make many variations of video clips. To produce a video clip, the artist may perform several editing iterations until the clip has the desired look and feel of the artist. In the process, the artist may go back to one or more previous versions, which may not be the latest version. Also, the artist may need to incorporate scenes produced by other artists, but the artist may not know the file name or correct version of the file including scenes to be incorporated. Instead, the only thing the artist may know is that these files have certain semantics. This situation arises in a variety of applications and environments, including universities, research laboratories, medical institutions, etc.

### SUMMARY OF THE INVENTION

According to an embodiment of the invention, a method for generating a snapshot of a file system operable to store a plurality of objects comprises receiving a snapshot time identifying a point in time in a history of the file system; and identifying at least one object available at the snapshot time based on one or more of a creation timestamp and an invisible_after timestamp for the at least one object.

According to another embodiment of the invention, a file system operable to store a plurality of objects comprises means for receiving a snapshot time identifying a point in time in a history of the file system; and means for identifying at least one object available at the snapshot time based on one or more of a creation timestamp and an invisible_after timestamp for the at least one object.

According to yet another embodiment of the invention, an archival file system comprises a file system connected to the at least one client via a network, wherein the file system stores a first timestamp and a second time stamp for each of a plurality of objects in the file system. The file system is operable to generate a snapshot of the file system using the timestamps for each of the plurality of objects.

### BRIEF DESCRIPTION OF THE DRAWINGS

The present invention is illustrated by way of example and not limitation in the accompanying figures in which like numeral references refer to like elements, and wherein:

FIG. 1A illustrates a semantic-based system, according to an embodiment of the invention;

FIG. 1B illustrates a layered view of a system architecture of the system shown in FIG. 1A;

FIG. 2 illustrates a semantic catalogue, according to an embodiment of the invention;

FIG. 3 illustrates a flow diagram of a method for searching a semantic-based file system, according to an embodiment of the invention;

FIG. 4 illustrates views of the file system of FIG. 1 at particular times, according to an embodiment of the invention;

FIG. 5 illustrates a flow diagram of a method for generating a snapshot of the file system of FIG. 1, according to an embodiment of the invention; and

FIG. 6 illustrates a computer platform for a node in a P2P system, according to an embodiment of the invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

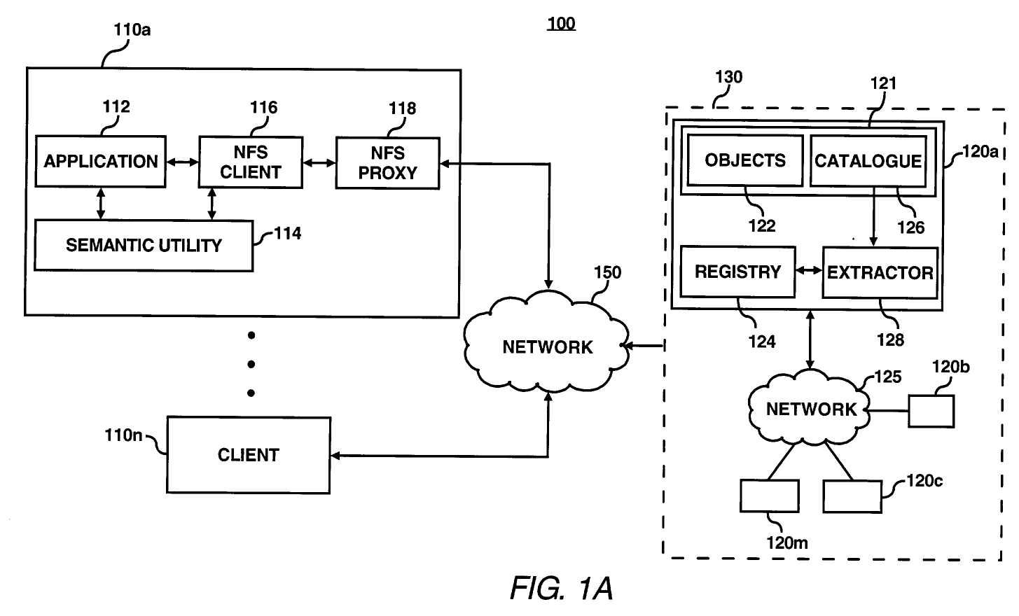

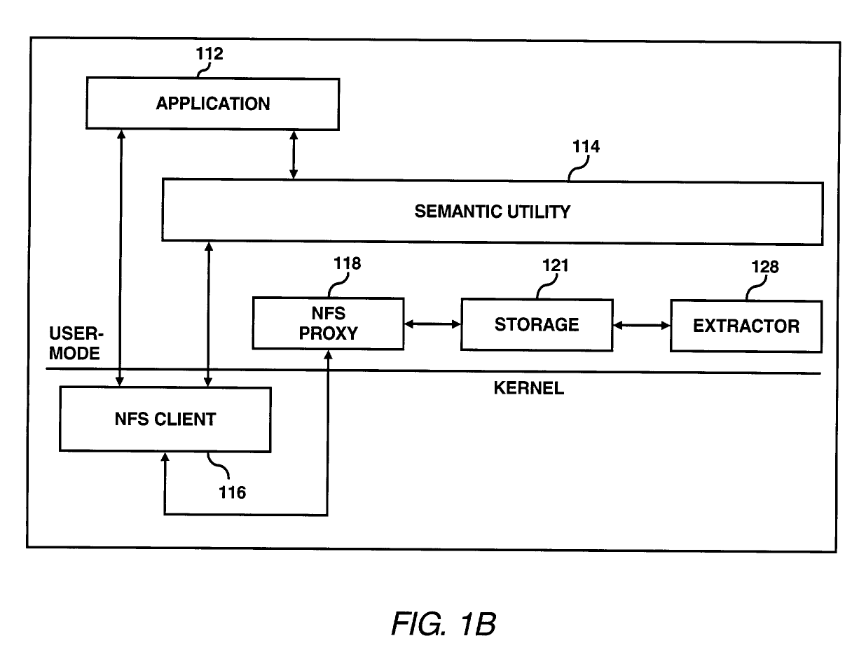

FIG. 1A illustrates an exemplary block diagram of a system 100 where an embodiment of the present invention may be practiced. It should be readily apparent to those of ordinary skill in the art that the system 100 depicted in FIG. 1 represents a generalized schematic illustration and that other components may be added or existing components may be removed or modified without departing from the spirit or scope of the present invention.

As shown in FIG. 1A, the system 100 comprises a semantic archival system. The system 100 provides a semantic-based interface that allows clients to locate files according to the semantics in the files.

The system 100 includes clients 110a . . . n connected to a distributed archival file system (dafs) 130 via a network 150. According to an embodiment of the invention the dafs 130 may include a peer-to-peer (P2P) system having nodes 120a . . . m connected via a network 125. It will be apparent to one of ordinary skill in the art that a client may also be a node in the dafs 130. Furthermore, the networks 125 and 150 may include one or more of the same networks. By using a P2P system, the dafs 130 may benefit from vast storage capabilities of P2P systems, which can allow the dafs 130 to store substantially every version of an object (e.g., files, directories, documents, etc.). It will be apparent to one of ordinary skill in the art that the dafs 130 is not limited to a P2P system and may use other types of distributed systems.

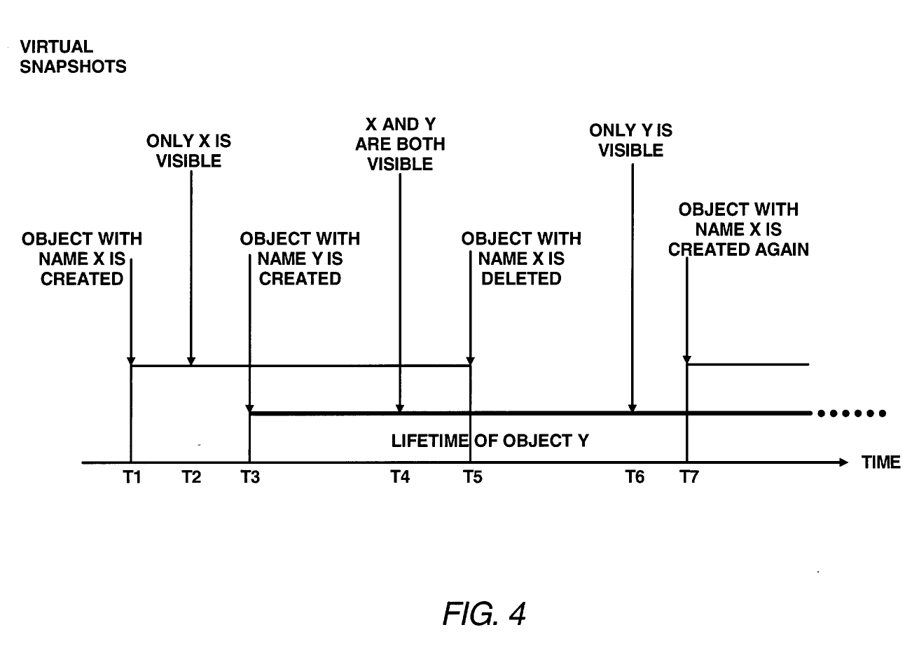

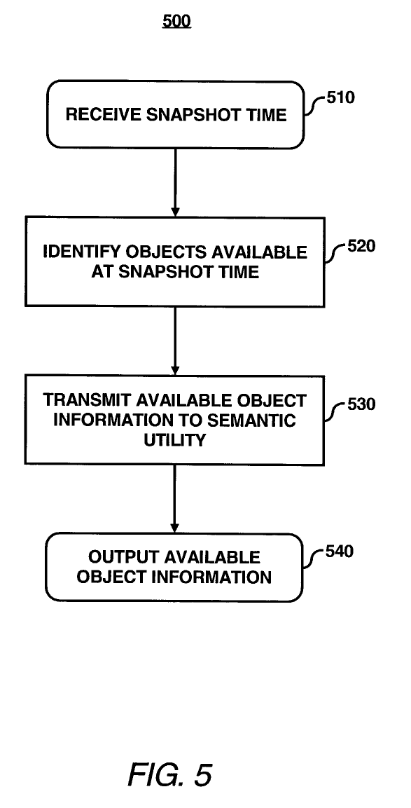

In the dafs 130, each time a file is modified and closed, a new version of the file is produced. Different instances of the same file will be given a different version number. Directories, however, may not be versioned, but the dafs 130 supports a virtual snapshotting which uses timestamps. Virtual snapshotting allows accessing the namespace arbitrarily back in time. Virtual snapshotting is described in detail below with respect to FIGS. 4 and 5.

The dafs 130 includes a storage 121 storing objects 122 (e.g., files, directories, etc.) and a semantic catalogue 126 including semantic vectors. The dafs 130 also includes an extractor 128, and an extractor registry 124. The semantic catalogue 126 is metadata that describes the semantics of each object 122. The semantic catalogue may be a distributed index stored in the nodes 120a . . . m. The semantic catalogue 126 contains an index of semantic vectors for objects in the dafs 130. A semantic vector includes semantic information about an object. The semantic information may be related to predetermined features that can be extracted from an object. A semantic vector may be file-type specific, such that predetermined features are extracted for each object file type. The semantic vector may include a bit wise representation in the semantic catalogue 126.

The predetermined features in a semantic vector may be extracted from an object's contents, such as features extracted from contents of a file. For example, for a text file features, such as word or term frequency information, are extracted from text documents to derive a semantic vector for the text file. Known latent semantic indexing techniques, such as matrix decomposition and truncation, may be used to extract information for creating the semantic vector. For music files, known techniques for deriving frequency, amplitude, and tempo features from encoded music data may be used to create semantic vectors. Additionally, one or more semantic vectors may be provided for other file types.

FIG. 1B illustrates a layered view of the system architecture for the system 100 shown in FIG. 1A. The application 112 and the and semantic utility 114 communicates with the dafs 130 via the NFS client 116 and the NFS proxy 116. The semantic utility 114 may access the semantic catalogue 126 and the objects 122 in the storage 121 (i.e., distributed storage) of the dafs 130. The storage 122 is also connected to the extractor 128 for extracting and storing semantic vectors and performing other functions.

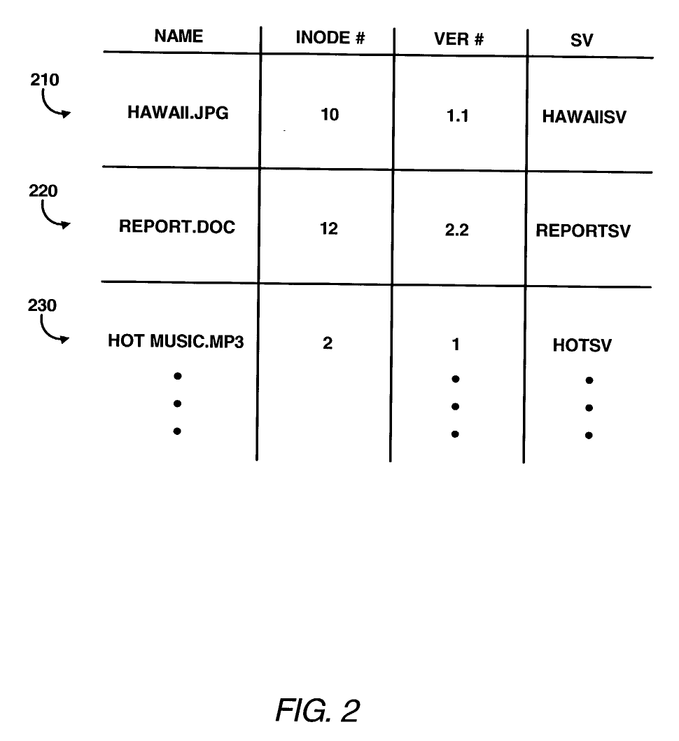

FIG. 2 illustrates entries 210-230 in the semantic catalogue 126. The fields of the catalogue 126 include, among others, file name, Inode, version number, and semantic vector. The Inode is a unique identifier of an object in the dafs 130. An Inode in the dafs 130 is similar to an Inode in a traditional UNIX file system, however, an Inode in the dafs 130 is a unique identifier in a distributed file system. Besides the metadata included in a traditional file system such as owner and permissions, an Inode in system 100 may also include the following information for each version of a file: version number, reference to the base file Inode, version number of the base file, (a “file Inode” and a “version number” may be used to uniquely identify a particular version of a file), reference to the diff Inode, and the identifier of the function to reconstruct the file content from the base file and the diff. The storage capabilities of the P2P platform may allow for storage of substantially every version of a file and an Inode for every version. Therefore, Inodes in the system 100 may include information regarding substantially every version of a file. For each version of a file, some information needs to be stored in both the Inode and the semantic catalogue 126, such as the version number. As described above, the Inode of a directory entry may not include version information. However, a timestamp may be used to provide a snapshot of the namespace at a predetermined time.

The entry 210 in FIG. 2 is for the file hawaii.jpg. It is located at Inode 10 and is version 1.1. A semantic vector HAWAIISV may be derived based on predetermined features of JPEG files. The entry 220 is for report.doc. It is located at the Inode 12 and is version 2.2. A semantic vector REPORTSV may be derived based on predetermined features of doc files. The entry 230 is for the file hot music.mp3. It is located at Inode 2 and is version 1. A semantic vector HOTSV may be derived based on predetermined features of MP3 files.

The catalogue 126 may include other fields, such as Inode of a base document and identification of a diff. The dafs 130 may use a diff function to derive differences between a new version and a previous version. Instead of storing each new version, just the differences (i.e., a diff) between the new version and the old version are stored to conserve storage. Other fields may include owner, creation time, deletion time, etc.

The dafs 130 also includes an extractor registry 124, such as in the nodes 120a . . . m. The extractor registry 124 lists all the extractors available for creating semantic vectors. An extractor 128 is connected to the extractor registry 124. The extractor 128 may include a plug-in for creating semantic vectors. Multiple extractors, wherein each extractor may be specific to a file type, may be stored for creating semantic vectors for different file types. For data of unknown types, statistical analysis can be used to derive features from a file. Each extractor may utilize known algorithms for extracting semantic information to create a semantic vector for a file. Both the extractor 128 and the extractor registry may include software executed at a node in the dafs 130.

A node 120a, for example, may write a new object to the storage 121. The extractor registry may be consulted to determine which extractor is used to automatically create a semantic vector for the new object. The extractor registry 124 may also provide an extensible interface that allows new extractors and diff functions to be added.

The system 100 also includes one or more of the clients 110a . . . m which perform data operations on the dafs 130. Data operations may include conventional network file system operations to access file and directory systems in the dafs 130, such as cd, ls, mkdir, mv, rm, etc. The dafs 130 also executes additional commands for executing semantic-based queries and utilizing information in the semantic catalogue 126. The clients 110a . . . m may include application(s) 12 reading/writing information to the dafs 130.

A semantic utility 114 is also included in the clients 110a . . . m. The semantic utility 114 offers semantic-based retrieval capabilities by interacting with the dafs 130. The semantic utility 114 may include a user interface allowing a user to create and execute a semantic-based query.

The semantic utility 114 interacts with the dafs 130 to generate materialized views of query results. Users can access these materialized views as regular file system objects. For example, a user can execute commands using the semantic utility 114 to create results of a query into a directory, such as using the following commands:

sdr-mkdir cn;

sdr-cp “similar to ‘hawaii.jpg’” cn.

The directory cn contain links to files that are semantically close to the sample file, hawaii.jpg. Directories like “cn” are called semantic directories, which can be accessed as a regular directory. Note that the command sdr-cp “similar to ‘hawaii.jpg’” cn is a semantic-based query which can be used to view and later retrieve files similar to “hawaiijpg.”

Semantic-based queries include one or more features for identifying objects having the features. These features may be associated with one or more of the features extracted from the objects 122 to create the semantic vectors 123. Semantic-based queries can also be constrained. Typical constraints may include time and namespace. For example, a user can search for files created after Jan. 1, 1999 by issuing a command (e.g., sdr-ls “after Jan. 1, 1999”). Similarly, the user can search for files under a list of directories (e.g., sdr-ls “computer networks' under /etc, cn/; before Jan. 1, 1999”). The directories can be “semantic directories” with a hierarchal file system employed on the nodes 110a . . . 110n functioning as peers in a P2P system.

The NFS client 116 and the NFS proxy agent 118 include software allowing a user to connect to the dafs 130. The NFS client 116 provides backward compatibility for the application 112 to use the dafs 130. The NFS proxy agent accepts NFS requests and other requests specific to the dafs 130 converts the requests to a protocol understood by the dafs 130. Although not shown, the nodes 120a . . . n may include similar application program interfaces allowing the nodes 120a . . . n to execute file system commands.

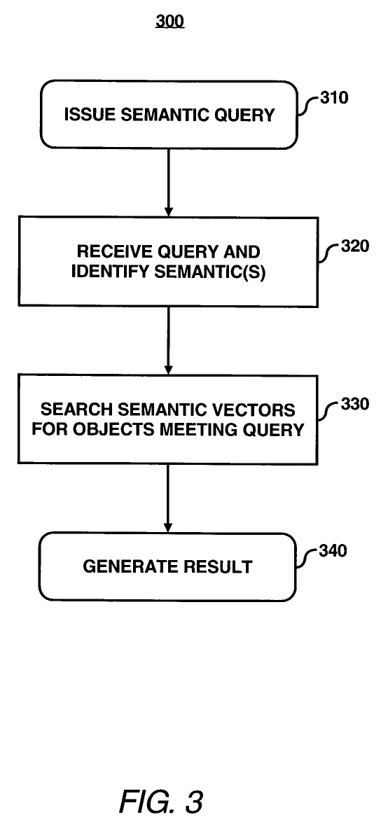

FIG. 3 illustrates a method 300 for retrieving an object using a semantic vector, according to an embodiment of the invention. In step 310 a semantic query is issued by a user which results in a search for one or more objects using one or more semantics identified from the query. For example, the command sdr-cp “similar to ‘hawaii.jpg’” cn is a semantic-based query which results in a search for objects similar to Hawaii.jpg. Semantics for the search are retrieved from HAWAIISV. Another example may include a user deriving a semantic vector for a document. Then, the user uses the derived semantic vector to search for similar documents in the dafs 130.

A semantic search based on semantic vectors can be file-type specific. Generally speaking, some kind of Euclidian distance between semantic vectors of two files may be used to measure the similarity of the two files. For instance, in text file searches, the similarity between two files (or a query and a file) is measured as the cosine of the angle between their corresponding semantic vectors. For other media such as video and audio, other techniques may be used to detect similarities between semantic vectors.

In step 320, the dafs receives the semantic query and identifies one or more semantics in the query. These semantics are used to search for objects in the dafs 130 having similar semantics.

In step 330, the dafs 130 searches semantic vectors in the semantic catalogue 126 to identify objects meeting the query. For example, semantic vectors are identified that have the semantics from the query.

In step 340, the dafs 130 generates a result of the search. For example, the directory cn is created including the results of the search. A user may use the semantic utility 114 to view results of a query. Steps for generating the result may also include identifying at least one object from the catalogue meeting the query; identifying location of the object from the semantic catalogue; and retrieving the object from the location for transmission to the client.

Unlike metadata for files in the dafs 130, metadata for directories in the dafs 130 may not include version information. This may be done to avoid recursive updates leading all the way to the root when any namespace change occurs. Instead of storing version information for directories, timestamp information is stored. The timestamp information is stored for both files and directories (i.e., objects in the dafs 130), for example, in the Inode of an object. The timestamp information may also be stored in the catalogue 126 and provided with entries for objects in the dafs 130 as an optimization to speedup queries.

Objects may have two timestamps. A first timestamp is the creation timestamp, which is the time the object is created. For example, a directory's creation timestamp is the time it is created using, for example, a “mkdir” command. A file may have multiple versions, and each version has its own creation timestamp.

An invisible_after timestamp is the second timestamp. The invisible_after timestamp is used to implement a conceptual deletion technique that makes objects invisible (i.e., unavailable) to users after the invisible_after timestamp. The dafs 130 hides these objects from a user's view after the invisible_after timestamp. For example, if a user is requesting a snapshot of the dafs 130 at a particular time, such as through the semantic utility 114, objects with an invisible_after timestamp before the requested snapshot time are hidden. Also, each timestamp may include a data and a time.

The dafs (130) may assume the clocks on the nodes 110a . . . n are loosely synchronized. For example, a clock for node 110a may have a time of 3 PM at one point in time, and a clock for node 110b may have a time of 4 PM at the same point in time. Therefore, creation timestamps and invisible_after timestamps may be loosely used as thresholds for determining availability at a snapshot time. For example, if an object has a creation timestamp approximately before a snapshot time and an invisible_after timestamp approximately after the snapshot time, the object is available at the snapshot time. Alternatively, a clock synchronization algorithm may be implemented for substantially synchronizing the clocks.

A hidden object is unavailable and generally cannot be accessed by a user. For example, enters a command to list all the files in a directory. Hidden files in the directory are not listed. An object may be hidden, for example, through a delete file operation or a remove directory operation. These objects are not actually deleted from the dafs 130. Instead they are hidden after the operation. The invisible_after timestamp may be set at the time of the operation. As a consequence, a user can recover the state of the dafs 130 at any particular time point in the history of the dafs 130. If an object is not hidden, the object is available to a user. For example, a user may access the object.

Given the two timestamps for each object, the dafs 130 does not need to store versions of the directories. Therefore, at the time of making a snapshot, rather than replicating the metadata for files and directories, the dafs 130 need only record the time of the snapshot event, e.g., a snapshot is taken at time ts, then ts is recorded.

FIG. 4 illustrates how timestamps are used to view a snapshot of the dafs 130 at any point in time. Time T1 is the creation timestamp for an object X. A snapshot of the dafs 130 at time T2 shows the object X if the object X was the only object visible in the namespace at that time. Time T3 is the creation timestamp for an object Y. A snapshot of the dafs 130 at the time T4 shows objects X and Y.

Time T5 is the invisible_after timestamp for the object X, because the object X is hidden by the dafs 130 at that time. For example, if the object is a file, a delete operation is performed and the file is hidden after the time T5. If the object is a directory, a remove directory operation may be performed. Then, the directory and all the files in the directory are hidden. A snapshot at the time T6 only shows the object Y, because the object X is hidden. Time T7 is the creation timestamp for a new version of the object X, and both objects X and Y are visible after the time T7 until one or more of the objects X and Y are hidden.

FIG. 5 illustrates a method 500 for listing all files for a snapshot of the dafs 130 according to an embodiment of the invention. At step 510 a snapshot time for generating a view of the dafs 130 at that time is received by the dafs 130. For example, a user inputs the snapshot time into the semantic utility 114, and the semantic utility send a query to the dafs 130, for example the root directory, including the snapshot time.

At step 520, the dafs 130 identifies objects that are available at the snapshot time. An available object is an object that is not hidden by the dafs 130. Available objects may be accessed by a user. A determination is made as to whether each object has a creation timestamp before the snapshot time and an invisible_after timestamp after the snapshot time. For example, creation timestamps and invisible_after timestamps are stored in the directory entries and Inode entries for the files. A comparison can be made for each entry.

At step 530, the dafs 130 transmits available object information to the semantic utility 114. The available object information identifies each object available at the snapshot time.

At step 540, the available object information is output to the user via the semantic utility 114. For example, the semantic utility 114 may display all the available objects at the snapshot time. The dafs 130 may include a deep archival file system that can store every version of a file. Therefore, using the semantic utility 114, the user can access files available at the snapshot time. This snapshot utility may be beneficial for a variety of applications. For example, when debugging, a program may rely on a particular version of a header file. A user can view the version of the header file available at the time the program was created to identify features of that header file that may be different from the present header file.

The steps of the methods 300 and 500 may be performed by one or more computer programs. The computer programs may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be operable to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

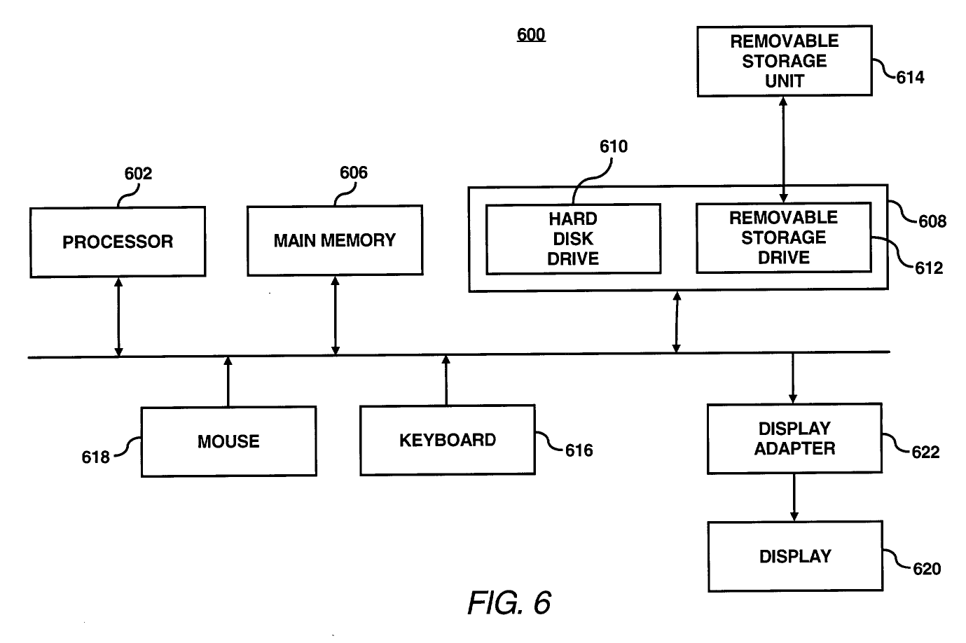

FIG. 6 illustrates an exemplary computer platform 600, according to an embodiment of the invention, for any of the nodes 120a . . . m or any of the clients 110a . . . n. The platform includes one or more processors, such as the processor 602, that provide an execution platform for software. The software, for example, may execute the steps of the method 600, perform standard P2P functions, etc. Commands and data from the processor 602 are communicated over a communication bus 604. The platform 600 also includes a main memory 606, such as a Random Access Memory (RAM), where the software may be executed during runtime, and a secondary memory 608. The secondary memory 608 includes, for example, a hard disk drive 610 and/or a removable storage drive 612, representing a floppy diskette drive, a magnetic tape drive, a compact disk drive, etc., where a copy of a computer program embodiment for the peer privacy module may be stored. The removable storage drive 612 reads from and/or writes to a removable storage unit 614 in a well-known manner. A user interfaces may interface with the platform 600 with a keyboard 616, a mouse 618, and a display 620. The display adaptor 622 interfaces with the communication bus 604 and the display 620 and receives display data from the processor 602 and converts the display data into display commands for the display 620.

While this invention has been described in conjunction with the specific embodiments thereof, it is evident that many alternatives, modifications and variations will be apparent to those skilled in the art. There are changes that may be made without departing from the spirit and scope of the invention.

What is claimed is:

1. A method for generating a snapshot of a file system operable to store a plurality of objects, the method comprising steps of:
receiving a snapshot time identifying a point in time in a history of the file system; and
identifying at least one object available from the file system at the snapshot time based on one or more of a creation timestamp and an invisible_after timestamp for the at least one object, wherein the creation timestamp is associated with a time the at least one object is created in the file system and the invisible_after timestamp is associated with a time the at least one object is made unavailable from the file system.

2. The method of claim 1, further comprising transmitting object information to a client of the file system, the object information including information about the at least one identified object.

3. The method of claim 1, further comprising steps of:
generating a creation timestamp for each of a plurality of objects in the file system; and
generating an invisible_after timestamp for each of the plurality of objects in the file system.

4. The method of claim 3, wherein the step of identifying at least one object further comprises steps of:
determining whether a creation timestamp for the at least one object is approximately before the snapshot time;
determining whether an invisible_after timestamp for the at least one object is approximately after the snapshot time; and
identifying the at least one object as available in response to the creation timestamp being approximately before the snapshot time and the invisible_after timestamp for the at least one object being approximately after the snapshot time.

5. The method of claim 4, further comprising repeating the steps of claim 4 for each object in the file system to identify whether each object is available at the snapshot time.

6. The method of claim 2, wherein the step of transmitting further comprises transmitting the object information to a file system utility on the client.

7. The method of claim 6, further comprising displaying the object information using the file system utility, the displayed object information including information regarding any object available from the file system at the snapshot time.

8. The method of claim 1, wherein the file system is an archival system operable to store multiple versions of a file.

9. The method of claim 3, wherein the file system is a semantic, archival, file system storing a semantic catalogue including an entry for each object in the file system, and the step of generating a creation timestamp further comprises storing the creation timestamp for each object in an associated entry in the semantic catalogue; and
the step of generating an invisible_after timestamp further comprises storing the invisible_after timestamp for each object in an associated entry in the semantic catalogue.

10. A file system operable to store a plurality of objects comprising:
means for receiving a snapshot time; and
means for identifying at least one object available from the file system at the snapshot time based on one or more of a creation timestamp and an invisible_after timestamp for the at least one object, wherein the creation timestamp is associated with a time the at least one object is created in the file system and the invisible_after timestamp is associated with a time the at least one object is made unavailable from the file system.

11. The file system of claim 10, further comprising means for transmitting object information to a client of the file system, the object information including information about the at least one identified object.

12. The file system of claim 10, further comprising:
means for generating a creation timestamp for each of a plurality of objects in the file system; and
means for generating an invisible_after timestamp for each of the plurality of objects in the file system.

13. The file system of claim 12, wherein the means for identifying at least one object further comprises:
means for determining whether a creation timestamp for the at least one object is approximately before the snapshot time;
means determining whether an invisible_after timestamp for the at least one object is approximately after the snapshot time; and
means for identifying the object as available in response to the creation timestamp being approximately before the snapshot time and the invisible_after timestamp for the object being approximately after the snapshot time.

14. The file system of claim 11, wherein the means for transmitting further comprises transmitting the object information to a file system utility on the client.

15. The file system of claim 14, wherein the client further comprises means for displaying the object information using the file system utility, the displayed object information including information regarding any object available from the file system at the snapshot time.

16. The file system of claim 12, further comprising a semantic, archival, file system storing a semantic catalogue including an entry for each object in the file system.

17. The file system of claim 16, wherein the means for generating a creation timestamp further comprises means for storing the creation timestamp for each object in an associated entry in the semantic catalogue; and
the means for generating an invisible_after timestamp further comprises means for storing the invisible_after timestamp for each object in an associated entry in the semantic catalogue.

18. An archival file system comprising:
a file system connected to at least one client via a network, wherein the file system stores a first timestamp and a second time stamp for each of a plurality of objects in the file system; and
the file system is operable to generate a snapshot of the file system using the timestamps for each of the plurality of objects.

19. The archival file system of claim 18, wherein the file system is on a P2P platform.

20. The archival file system of claim 18, further comprising a semantic catalogue storing semantic information for the plurality of objects.
